(19) United States
(12) Patent Application Publication
(10) Pub. No.: US 2024/0034031 A1
(43) Pub. Date: Feb. 1, 2024

(54) LAMINATED GLAZING WITH SEVERAL PANELS, OF WHICH A REGION FOR POSITIONING ADJACENT PANELS NEXT TO ONE ANOTHER IS REINFORCED BY INSERTING A STRUCTURING ELEMENT

(71) Applicant: SAINT-GOBAIN GLASS FRANCE, COURBEVOIE (FR)

(72) Inventors: Cyril LAGO-GOMEZ, BONNÉE (FR); Jean-Charles SAUVESTY, SULLY SUR LOIRE (FR)

(21) Appl. No.: 18/257,234

(22) PCT Filed: Dec. 13, 2021
(86) PCT No.: PCT/FR2021/052287

§ 371 Date: Jun. 13, 2023

(30) Foreign Application Priority Data
Dec. 14, 2020 (FR) FR2013196

(51) Int. Cl. B32B 17/10

(52) U.S. Cl. CPC B32B 17/10366; B32B 17/10036; B32B 17/1055; B32B 2605/00

(57) ABSTRACT

A laminated glazed unit includes at least first and a second elementary transparent laminated panels whose edges are next to one another and whose respective glass sheets are distinct and separated from one another, wherein the glass sheets of the first panel, on the one hand, and the glass sheets of the second panel, on the other hand, are joined together in pairs by an intermediate adhesive layer which is rigidly attached to the surface of the assembly of the first and second panels and wherein, in a region in which the first and second panels are positioned next to one another, a structuring element is inserted into the interlayer adhesive layer.

The invention relates to the field of glazed units of land, air, and water vehicles that are subject to stresses that may be of mechanical (pressure, impact, etc.), thermal, or thermomechanical origin. Currently, on different types of vehicles having complex shapes, the vision zone allowing the drivers or passengers to have a view towards the outside of the vehicle is interspersed with structure zones belonging to the vehicles and forming bearing zones for the attachment of the glazed units. For example, on an airplane, the vision zone is cut from several parts incorporating structural uprights, thus limiting the vision zone. On a helicopter, there are structural elements but also glazed unit frames incorporating fasteners.

This technique of sub-assemblies of glazed zones separated by structural elements has several drawbacks.

A first drawback is the reduction in the vision zone: the occupants of the craft have a relatively reduced vision zone due to the size of the structural elements. The areas are all the smaller when the glazed units are framed, to include the attachment elements (screws, rivets, etc.) between the glazed areas.

A second drawback is the increase in mass: from a mechanical stress point of view, there are changes in cross-sections, materials and neutral fiber positions (zero stress zone), forcing the glazed unit and the structure to be sized with considerable thickness so that the assembly can withstand the various stresses. The mass of the sub-assembly is thereby greatly impacted.

A third drawback is the increase of the assembly/disassembly times; the operations take longer because each glazed unit must be mounted in its housing. The more glazed units there are, the longer the operations take.

There is therefore a need to provide a single assembly method for producing the structure and the glazed unit, the whole being integrated during the lamination/autoclaving operation of the transparent assembly.

This objective is met by the invention, whose subject-matter consequently is a laminated glazed unit comprising at least first and a second elementary transparent laminated panels whose edges are next to one another and whose respective glass sheets are distinct and separated from one another, characterized in that the glass sheets of the first panel, on the one hand, and the glass sheets of the second panel, on the other hand, are joined together in pairs by an intermediate adhesive layer which is rigidly attached to the surface of the assembly of the first and second panels and in that, in a region in which the first and second panels are positioned next to one another, a structuring element is inserted into the intermediate adhesive layer. The laminated glazed unit is made of several parts (panels). A structuring element is integrated into the glazed unit during its lamination, so as to be superimposed on at least one area of contiguous edges of two neighboring (adjacent) panels, over a certain width on either side of these contiguous edges. As will be seen in more detail below, the material and dimensions of the structuring element are chosen so as to allow the laminated glazed unit to withstand the different loading cases to which it is subjected. When impacted by a bird, for example, the structuring element may be caused to break, though without generating a safety problem, as the different panels of the glazed unit are also linked by one or more layers or sheets of polymer material, in particular intermediate adhesive layers. The structuring element provides the rigidity of the connection of the sub-assembly, the elements made of polymer material holding the assembly in the event of failure of the structuring element. In the event that the structuring element breaks, the bird resistance function is provided by the intermediate adhesive layer, a bonding material between the different panels making it possible to guarantee the sealing of the glazed unit vis-à-vis the impactor.

The number of glass sheets of the first panel on the one hand, and of the second on the other hand, are independently of each other equal to n₁ and n₂ which are integers that are identical or different greater than or equal to 2. If n₁ and n₂ are greater than or equal to 3, the glass sheets of the first panel on the one hand, the glass sheets of the second panel on the other hand, are bonded in pairs by at least two intermediate adhesive layers (in two different thickness levels of the laminated structure) which both separately can be made of the same material on the surface of the assembly of first and second panels. Then, in a region for positioning the first and second panels next to one another, a structuring element is inserted in one of these two intermediate adhesive layers, or in both, or even, in more complex laminates, in at least three such intermediate adhesive layers that are formed from the same piece on the surface of the assembly of first and second panels, at different thickness levels of the laminated structure.

The laminated glazed unit may comprise at least three, and for example up to seven elementary transparent laminated panels without departing from the scope of the invention. Their edges are then juxtaposed along at least two juxtaposition lines defining at least two juxtaposition zones (for example according to a band of a certain width on either side of each of the juxtaposition lines). In at least two of these juxtaposition zones, in all these juxtaposition zones or in only some of them, at least one structuring element is inserted into at least one intermediate adhesive layer. At least one of these juxtaposition zones may be devoid of a structuring element without departing from the scope of the invention.

Preferably, each glass sheet of the first panel is juxtaposed with a corresponding glass sheet of the second panel, with interposition of a gasket. The seal is made of organic material, such as polyurethane, silicone, or polysulfide, it has a sealing function, optionally has the flexibility required for an articulation, and is transparent or not.

Preferably, the structuring element is made of organic, mineral, composite or metallic material. Examples thereof are a thin sheet of glass that is chemically strengthened, a sheet of polymer material such as an unsaturated epoxy or polyester resin with reinforcing fibers such as glass fibers, carbon, aramid, etc.

Preferably, the glass sheets are made of mineral glass such as soda-lime, aluminosilicate or borosilicate glass, optionally hardened, thermally tempered, or chemically strengthened, or of organic glass such as poly(methyl methacrylate) (PMMA), polycarbonate (PC), polyethylene terephthalate (PET) or polyurethane (PU).

Preferably, the (each) intermediate adhesive layer is made of polyvinyl butyral (PVB), thermoplastic polyurethane (TPU), ethylene-vinyl acetate copolymer (EVA) or ionomer resin such as poly(acrylic acid) partially neutralized by a polyamine.

Preferably, at least the first and the second elementary transparent laminated panels are each composed of at least three glass sheets bonded in pairs by an intermediate adhesive layer which is rigidly attached to the surface of the assembly of first and second panels, and in a juxtaposition zone of the first and second panels, a structuring element is inserted into at least two intermediate adhesive layers (with two thickness levels of the laminated structure), in all or not all of these at least two intermediate adhesive layers.

In a first variant, the structuring element extends over the entire juxtaposition zone of the first and second panels. These terms refer to a continuous zone extending over the entire length on which the edges of the two panels are positioned next to one another, for example in accordance with a band.

In a second variant, the structuring element extends over one part or several separate parts of the juxtaposition zone of the first and second panels. When several structuring elements in this juxtaposition zone are inserted in intermediate adhesive layers at different thickness levels of the laminated structure, they can extend independently of one another over the entire juxtaposition zone (length) of the edges of the two panels, on only one part or on several separate parts of this juxtaposition zone. These different structuring elements may be of identical or different materials, identical or different dimensions in the thickness of the laminate or in the plane of its two main surfaces, so as to be more or less superposable, or on the contrary they may be distinct. Mechanical strength effects as well as aesthetic properties may result from these different modes.

Preferably, the laminated glazed unit comprises at least a first, a second and a third elementary transparent laminated panels, up to seven in particular. At least two juxtaposition zones between two adjacent elementary panels are then defined, at least one structuring element being inserted in all these juxtaposition zones, or only in some or only one of them.

The subject matter of the invention is also the application of a laminated glazed unit defined previously as glazed unit for attachment by bonding, bolting or pinching, particularly as glazed unit for an aerial vehicle, in particular a drone, an airplane, in particular a business jet or passenger plane, or helicopter, or a land vehicle, particularly a road or rail vehicle, or a watercraft.

The invention will be better understood in the context of the description of the appended drawings, in which

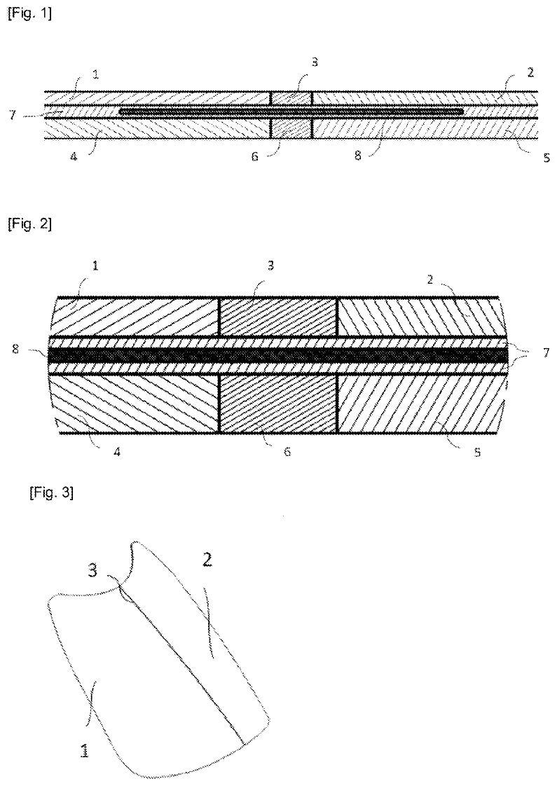

FIG. 1 is a schematic representation in cross-sectional view of a laminated glazed unit according to the invention.

FIG. 2 is an enlarged view of the-cross section of FIG. 1 in the juxtaposition zone of the first and of the second panels.

FIG. 3 is a front view of a double windshield intended to occupy the surface of two windshields of the prior art, separated by a vertical structural upright forming part of the cockpit of an aircraft.

With reference to FIGS. 1 and 2, a laminated glazed unit according to the invention comprises a first and a second elementary transparent laminated panels. The first elementary laminated panel consists of a first glass sheet 1 bonded to a second glass sheet 4 by means of an intermediate adhesive layer 7. The second elementary panel consists of a first glass sheet 2 bonded to a second glass sheet 5 by the intermediate adhesive layer 7 which is rigidly attached to the entire extent of the first and second panels. The first glass sheets 1, 2 of the first and second panels are made of the same material, for example chemically-strengthened aluminosilicate glass with a thickness suitable for the use of the glazed unit, in particular between 2 and 8 mm. The second glass sheets 4, 5 of the first and second panels are also made of the same material, for example chemically-strengthened aluminosilicate glass or soda-lime glass thermally tempered with a thickness of between 2 and 8 mm, or poly(methyl methacrylate) (PMMA), polyurethane (PU) or polycarbonate (PC) with a thickness of between 3 and 16 mm. If these latter 4, 5 are made of mineral glass, the intermediate adhesive layer 7 is made of polyvinyl butyral (PVB) with a thickness of between 0.38 and 8 mm, if they are made of polymer material, the intermediate adhesive layer is made of thermoplastic polyurethane (TPU) with a thickness of between 0.5 and 10 mm.

The edges of the first and second elementary panels define corresponding profiles making it possible to join them perfectly as shown.

A structuring element 8 is embedded in the intermediate adhesive layer 7 only in the juxtaposition zone of the two panels, in accordance with a band on either side of their juxtaposition profile (boundary between the two panels). The structuring element 8 is transparent and made of chemically-strengthened glass, for example from 1 to 2.5 mm thick, or metal from 0.5 to 4 mm thick, or thermosetting resin strengthened with glass or aramid reinforcing fibers, from 0.7 to 3 mm thick.

The first, respectively second glass sheets 1, 2, respectively 4, 5 of the first and second panels are connected in a sealed manner by a seal 3, respectively 6 made of a compressible, potentially transparent deformable polymer material, such as polyurethane, silicone or polysulfide.

FIG. 3 shows a windshield of relatively large surface area, the complete contour of the outer first glass sheets 1, 2 of the first and second panels constituting the entire laminated windshield, as well as the seal 3 connecting these first glass sheets 1, 2. The seal is very fine and discrete relative to the entire surface of the windshield.

The invention thus makes it possible to increase the field of view of the user, pilot, or passenger, by eliminating or decreasing the use of structural uprights forming part of the body/cockpit of the vehicle, or mounting frames that partially and incompletely separate glazed surfaces. Conversely, the invention provides relatively large and entirely transparent surfaces, free of intermediate structural uprights for the attachment of the glazed units. The assembly and disassembly thereof is simplified and faster.

1. A laminated glazed unit comprising at least first and a second elementary transparent laminated panels whose edges are juxtaposed and whose respective glass sheets are distinct and separated from one another, wherein the glass sheets of the first panel and the glass sheets of the second panel are joined together in pairs by an intermediate adhesive layer which is rigidly attached to a surface of an assembly of the first and second panels and wherein, in a region in which the first and second panels are juxtaposed, a structuring element is inserted into the intermediate adhesive layer.

2. The laminated glazed unit according to claim 1, wherein each glass sheet of the first panel is juxtaposed with a corresponding glass sheet of the second panel, with interposition of a gasket.

3. The laminated glazed unit according to claim 1, wherein the structuring element is made of organic, mineral, composite or metallic material.

4. The laminated glazed unit according to claim 1, wherein the glass sheets are made of mineral glass, or of organic glass.

5. The laminated glazed unit according to claim 1, wherein the intermediate adhesive layer is made of polyvinyl butyral (PVB), thermoplastic polyurethane (TPU), ethylene-vinyl acetate copolymer (EVA), or ionomer resin.

6. The laminated glazed unit according to claim 1, wherein at least the first and the second elementary transparent laminated panels each consist of at least three glass sheets bonded in pairs by an intermediate adhesive layer which is rigidly attached to the surface of the assembly of first and second panels, and wherein in a juxtaposition zone of the first and second panels, a structuring element is inserted into at least two intermediate adhesive layers.

7. The laminated glazed unit according to claim 1, wherein the structuring element extends over the entire juxtaposition zone of the first and second panels.

8. The laminated glazed unit according to claim 1, wherein the structuring element extends over part or several separate parts of the juxtaposition zone of the first and second panels.

9. The laminated glazed unit according to claim 1, comprising at least a first, a second and a third elementary transparent laminated panels.

10. A method comprising providing a glazed unit for attachment by bonding, bolting or pinching with the laminated glazing unit according to claim 1.

11. The method according to claim 10, wherein the glazed unit is a glazed unit for aerial vehicle or a land vehicle, or a watercraft.

12. The laminated glazed unit according to claim 4, wherein the mineral glass is soda-lime, aluminosilicate or borosilicate glass, optionally hardened, thermally tempered, or chemically strengthened, and the organic glass is poly(methyl methacrylate) (PMMA), polycarbonate (PC), polyethylene terephthalate (PET) or polyurethane (PU).

13. The method according to claim 11, wherein the aerial vehicle is a drone, a plane or a helicopter and the land vehicle is a road or rail vehicle.
